(19) United States
(12) Patent Application Publication
(10) Pub. No.: US 2015/0210006 A1
(43) Pub. Date: Jul. 30, 2015

(54) TAPE APPLICATOR ASSEMBLY

(71) Applicant: GaffTech, LLC, Cheyenne, WY (US)

(72) Inventors: Jonathan D. Harkless, Newcastle, WA (US); Daniel T. Kretz, Snoqualmie, WA (US); Jason P. Covey, Snoqualmie, WA (US)

(73) Assignee: GaffTech, LLC, Cheyenne, WY (US)

(21) Appl. No.: 14/166,656

(22) Filed: Jan. 28, 2014

(51) Int. Cl. B29C 65/50

(52) U.S. Cl. CPC B29C 65/5092

(57) ABSTRACT

A tape applicator assembly for securing tape to a surface includes a body and may include a centering and locking assembly configured to automatically center and lock a tape assembly within the body for dispensing. The tape applicator assembly may further be configured for securing tape to at least one cable and a surface, wherein the body includes a tape-receiving cavity defined for receiving a tape assembly having tape with a tape center longitudinal axis. A tape applying assembly may be defined within the body that is configured to adhere the tape to both the at least one cable and the surface. A cable alignment assembly may also be defined within the body that is configured to receive at least one cable positioned against the surface and substantially align the at least one cable with the tape center longitudinal axis.

### BACKGROUND

Gaffer tape is a specialized type of pressure-sensitive adhesive tape that is often used in the entertainment industry for securing cables to the stage floor or other surface, either for safety or to keep them out of view of the audience or camera. It is also widely used by audio-visual departments in hotels and conference centers for holding down wires to podiums and stages.

A “gaffer” or other technician will often run one or more cables (hereinafter sometimes referred to as a “cable run”) between two or more locations and then tape the cables to a surface. For instance, the cable run may extend between an electrical outlet and audio equipment, with the cable run taped to the floor, wall, or other surface. Before taping the cable run, or as the cable run is being taped to the surface, it is often desired to bundle, straighten, and pull the cable run taught. Aligning and bundling the cable run as it is being taped creates straighter tape lines, minimizes the strips of tapes used, reduces any tripping hazards, and makes the taped cable run more aesthetically pleasing.

It can be appreciated that aligning and bundling the cable run in this manner is a labor-intensive, imperfect process. The gaffer must bundle, align, and pull the cable run with one hand while taping the cable run to a surface with the other hand. Thus an improved device and method for securing aligned, bundled, taught cable(s) to a surface is desired.

As mentioned above, gaffer tape is a specialized type of pressure-sensitive adhesive tape often used to tape a cable run to a surface. The pressure-sensitive adhesive is sufficiently strong to secure the cable run to a surface until the tape is manually removed with a predetermined amount of force. Although gaffer tape is designed to be cleanly removed from cables (unlike a tackier tape such as duct tape), the tape can still get wrapped around or folded between the cable(s), causing the tape to stick to itself during the removal process. Moreover, when cables are “gaffed” often, adhesive residue builds up on the cables, making it more difficult to remove the tape from the cable. Thus, it can be further appreciated that an improved tape assembly suitable for use in gaffing cables is also desired.

### SUMMARY

A tape applicator assembly for securing tape to a surface includes a body and may include a centering and locking assembly configured to automatically center and lock a tape assembly within the body for dispensing. The tape applicator assembly may further be configured for securing tape to at least one cable and a surface, wherein the body includes a tape-receiving cavity defined for receiving a tape assembly having tape with a tape center longitudinal axis. A tape applying assembly may be defined within the body that is configured to adhere the tape to both the at least one cable and the surface. A cable alignment assembly may also be defined within the body that is configured to receive at least one cable positioned against the surface and substantially align the at least one cable with the tape center longitudinal axis.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is an environmental isometric view of a tape applicator assembly and tape assembly, wherein the tape applicator assembly and tape assembly are shown in use taping a cable run to a surface;

FIG. 2 is a cross-sectional view of a taped cable run of FIG. 1, taken substantially across line 2-2;

FIG. 3 is a partial top isometric view of the tape applicator assembly and tape assembly of FIG. 1;

FIG. 4 is a partial bottom isometric view of the tape applicator assembly and tape assembly of FIG. 1;

FIG. 5 is a partial cross-sectional view of the tape applicator assembly and tape assembly of FIG. 3, taken substantially across line 5-5, wherein the tape applicator assembly and tape assembly is shown in use taping cables to a surface; and

FIG. 6 is a cross-sectional view of the tape applicator assembly and tape assembly of FIG. 3, taken substantially across line 6-6;

FIG. 7 is an isometric view of the tape assembly of FIG. 1.

### DETAILED DESCRIPTION

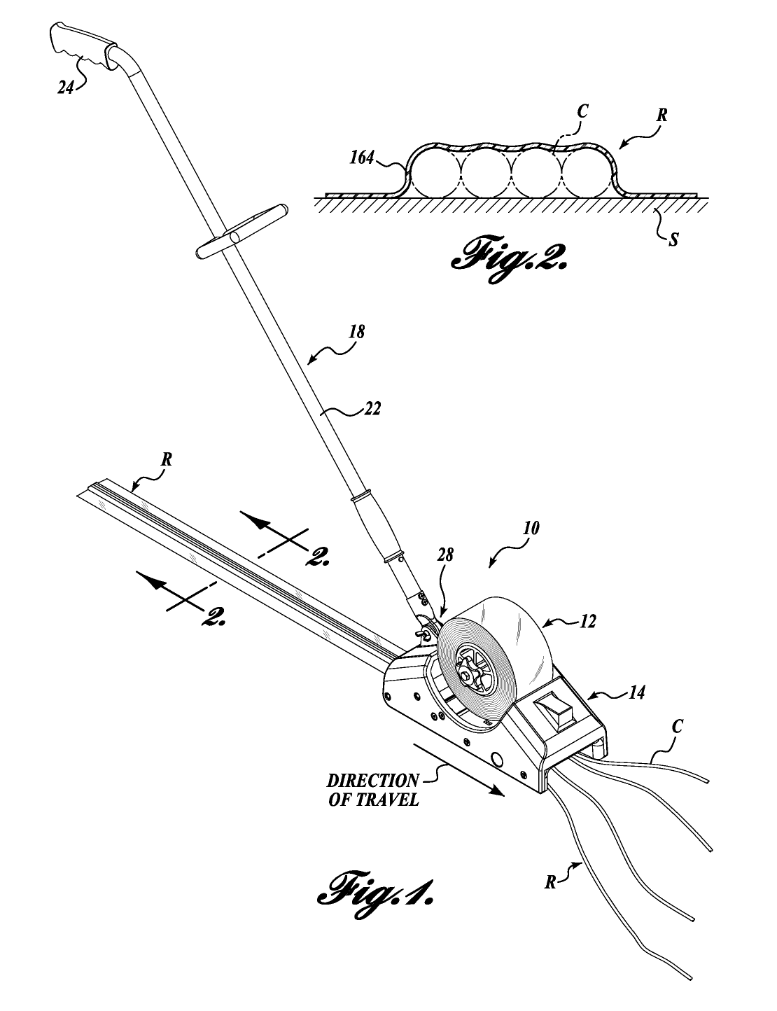

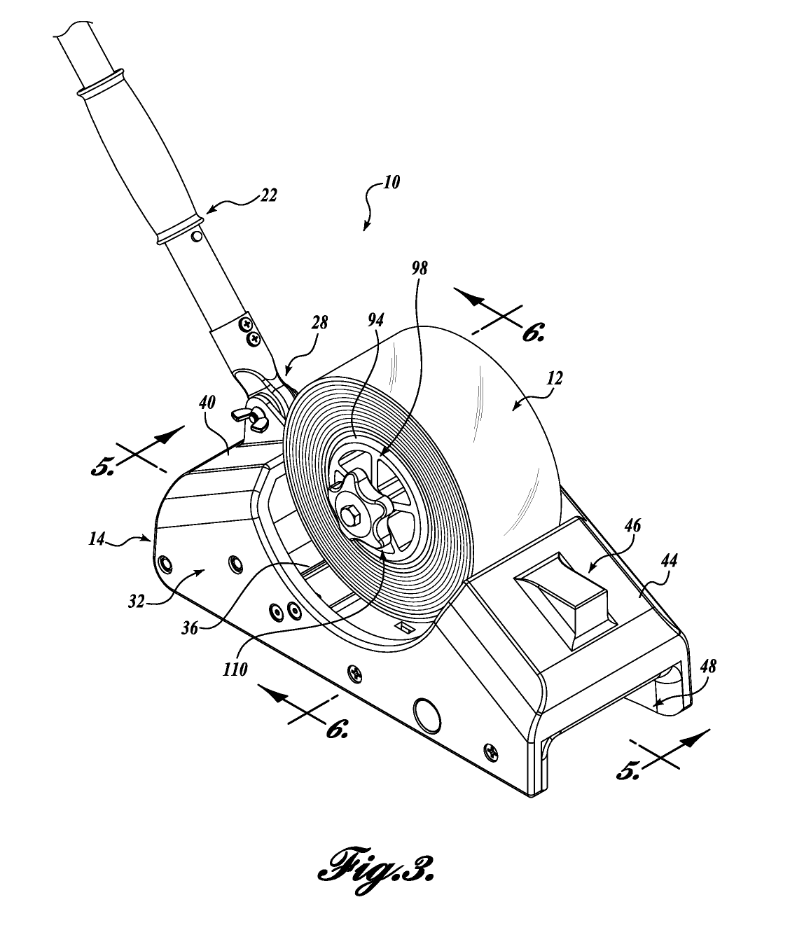

A tape applicator assembly 10 and tape assembly 12 formed in accordance with an exemplary embodiment of the present disclosure may best be seen by referring to FIG. 1. Referring additionally to FIG. 2, the tape applicator assembly 10 is configured to bundle, align, and tighten one or more cables C in a cable run R and tape the cable run R to a surface S. Although the tape applicator assembly 10 will be described as being used to tape a cable run R to a surface, it should be appreciated that the tape applicator assembly 10 may be used for any suitable purpose. For instance, the tape applicator assembly 10 may be used with a tape assembly 12 comprising gaffer tape suitable for taping cables to a surface. In the alternative, the tape applicator assembly 10 may be used with a tape assembly 12 comprising another suitable tape for temporarily fixing or labeling equipment, marking seating diagrams, walls, walkways, boundaries, etc. Thus, it should be appreciated that the descriptions and illustrations provided herein should not be seen as limiting the scope of the claimed subject matter.

The tape applicator assembly 10 includes a body 14 and a handle assembly 18 secured thereto. The handle assembly 18 is suitable for pushing, steering, and manipulating the body 14 against a surface. Although any suitable handle assembly may be used, in the depicted embodiment, the handle assembly 18 includes a stem 22 extending upwardly from the body 14, which may be pivotally connected to the body 14 through a pivot connection 28 or through any suitable means. The stem 22 may be adjustable in length, and it may be removable in the event that the user desires to grasp the body 14 for use. A suitable handle 24 is defined at the distal end of the stem 22 for grasping the handle assembly 18. Additional gripping devices, handles, etc., may be secured to the stem 22 for suitably pushing, steering, and manipulating the body 14 against a surface.

The body 14 is suitable for removably receiving a portion of the tape assembly 12 and taping a cable run R to a surface. Prior to taping the cable run R to a surface, the body 14 gathers, aligns, bundles, and tightens one or more cables C for creating an aesthically-pleasing, safe, taped cable run R.

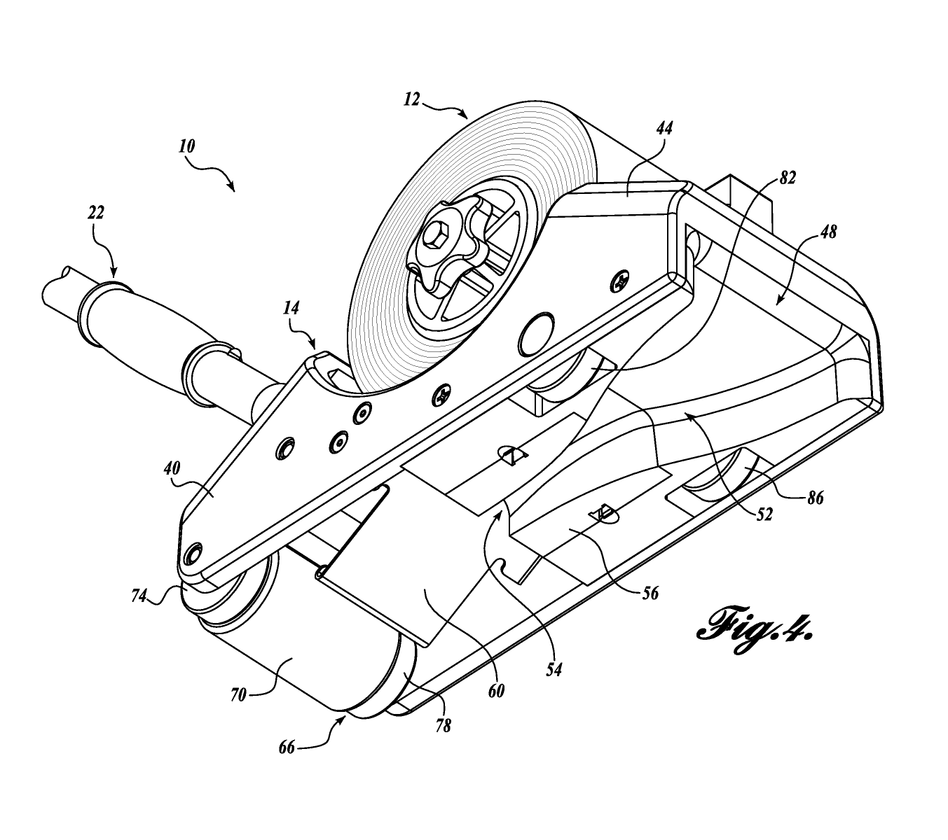

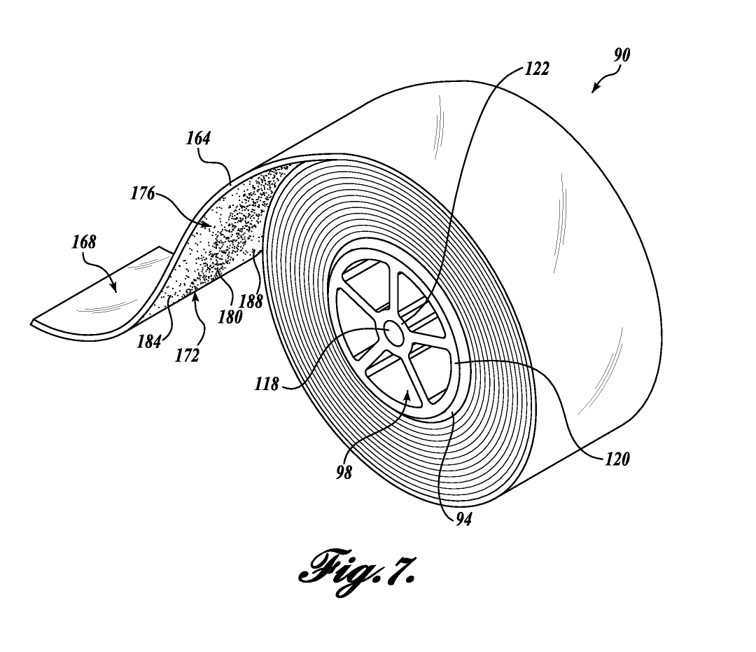

Referring to FIGS. 3-6, aspects of the body 14 for gathering, aligning, bundling, tightening, and taping one or more cables to a surface will now be described in detail. Referring specifically to FIG. 3, the body 14 includes an upper portion 32 having a tape-receiving cavity 36 defined between a rear portion 40 and a front portion 44. The handle stem 22 is pivotally secured to the rear portion 40 for pushing the body 14 forward over and along the desired cables on a surface.

A cable alignment assembly is defined within the body 14 for receiving and substantially aligning one or more cables positioned against a surface as the body moves along the surface. The cable alignment assembly may include an alignment device, such as a laser 46 or other light-centering mechanism, secured to or otherwise defined on the front portion 44. The laser 46 may project a beam onto the surface to help guide the user in taping a straight line of cables.

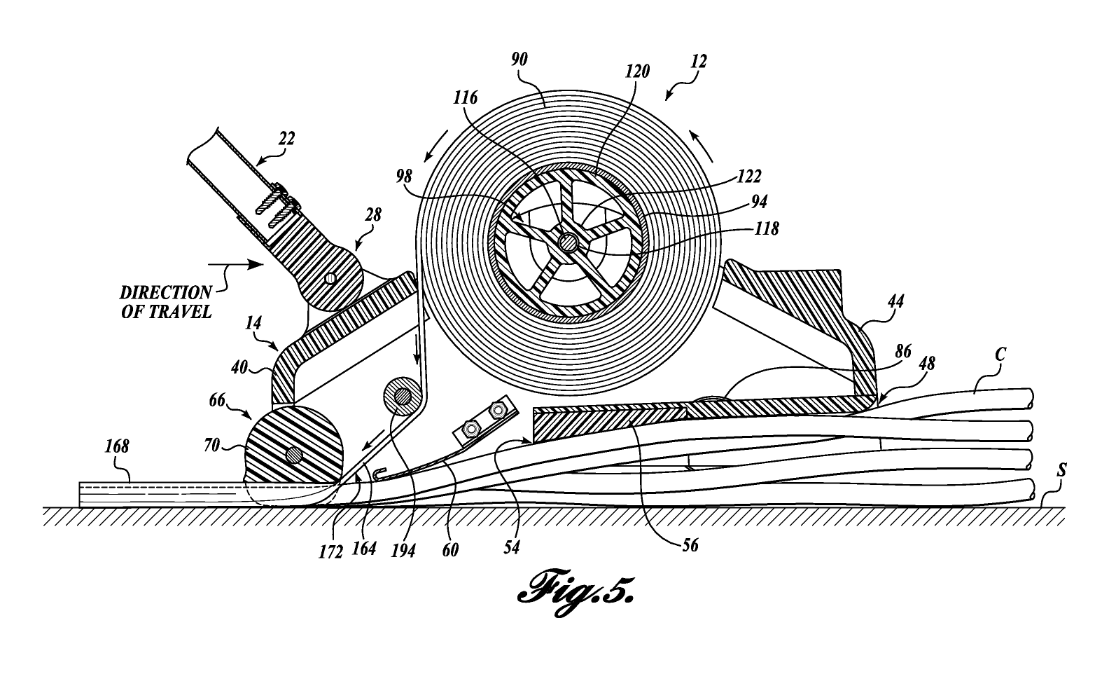

The cable alignment assembly further includes a front cable opening 48 is defined at a front end of the body 14 beneath the laser 46 that is suitable for receiving one or more cables positioned against a surface as the tape applicator assembly 10 is moved along the cables on the surface. Referring to FIG. 4, the front cable opening 48 is in communication with a funnel 52 that extends rearwardly along a bottom, interior, open surface of the body 14 and terminates in a rear cable opening 54. The funnel 52 tapers in width between the front and rear cable openings 48 and 54 for gathering and bundling the cables prior to being taped.

The funnel 52 may include a removable and/or adjustable rear funnel piece 56 at the rear end of the funnel 52 for adjusting the size of the rear cable opening 54. In the depicted embodiment, the rear funnel piece 56 is removably secured within the bottom of the body 14 by suitable snap-fit technology or other suitable means. The rear funnel piece 56 may be removed and replaced/interchanged with another rear funnel piece defining a larger or smaller rear cable opening 54 to bundle more or less cables for taping. In the alternative, the rear funnel piece 56 may include adjustment means for adjusting the size of the rear cable opening 54 without necessitating the removal of any pieces.

It should be appreciated that the size and shape of the rear funnel piece 56 may be configured to position one or more cables to be taped in a desired manner. For instance, the rear funnel piece 56 may include a small central opening to center and tape a single cable to a surface with tape. As another example, the rear funnel piece 56 may include a deeper and wider opening to center and bundle several cables for taping. As yet another example, the rear funnel piece 56 may include a wider, shallower opening for positioning several cables side by side for taping (see FIG. 2). Thus, it can be appreciated that the size, shape, and configuration of the rear funnel piece 56 may be designed for use in any desired configuration.

The cable alignment assembly further includes a suitable biasing or tensioning member is positioned rear of the funnel 52 for applying pressure and tension to the one or more cables as they are fed through the body 14. In the depicted embodiment, the tensioning member is embodied as a flat spring 60 configured to bias the funneled cables C away from the body 14 (i.e., toward the surface) as the body 14 is being moved along the cables C on the surface S. In that regard, the flat spring 60 is secured at its upper end to an interior portion of the body 14 and extends downwardly past the bottom, interior, open surface of the body 14 and toward the rear of the body 14 in an original, unbiased state. The flat spring 60 is movable into an upwardly flexed, biased position when engaged with the cables C. In the biased position, the flat spring 60 continuously engages and urges the cables C toward the surface S. By continuously applying tension to the cables, the cables are pulled taught and straight and are maintained in their centered, bundled positioned as tape is applied.

A tape applying assembly is defined within the body 14 and is in communication with the cable alignment assembly for applying tape to the aligned, bundled, tightened cables positioned on a surface. The tape applying assembly includes a rear wheel assembly 66 positioned rear of the flat spring 60 for applying tape to both the cables C and the surface S.

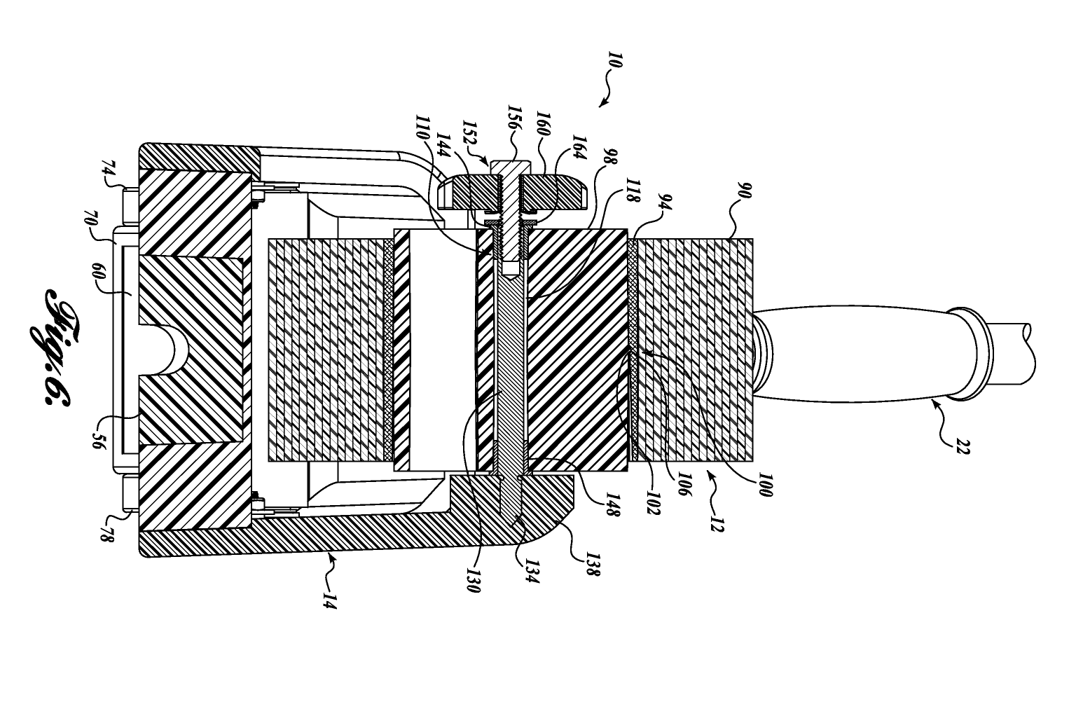

Referring to FIGS. 4 and 5, the rear wheel assembly 66 includes a middle tape applying portion 70 disposed between lateral rear rolling wheels 74 and 78. The lateral rear rolling wheels 74 and 78 are disposed on each lateral interior side of the body 14 and are journaled for rotation within the body 14 in any suitable manner, such as by a pin or rod (not labeled) extending through the rear wheel assembly 66 and rotatably received each lateral interior side of the body 14. The rear wheel assembly 66 is disposed within the body 14 such that the lateral rear rolling wheels 74 and 78 protrude from the bottom, rear, open surface of the body 14 for allowing the body 14 to roll against a desired surface.

In that regard, lateral front rolling wheels 82 and 86 protrude from the bottom, front surface of the body 14 on each lateral interior side of the body 14 to allow the body 14 to easily roll along a desired surface. The lateral front rolling wheels 82 and 86 may be positioned on each lateral side of the funnel 52 and may be journaled for rotation within the body 14 in any suitable manner, such as by a pin or rod (not labeled) rotatably extending through each front rolling wheel 82 and 86 and rotatably disposed within the respective lateral interior side of the body 14. With the rear and front lateral rolling wheels 74, 78, 82, and 86 disposed on the interior of the body 14, the body 14 may be easily positioned against a sidewall or other object as the body 14 is moved along a surface.

The middle tape applying portion 70 disposed between the lateral rear rolling wheels 74 and 78 is configured to apply tape and pressure to the bundled cables and the surface for securing the cables to a surface. In that regard, the middle tape applying portion 70 is sufficiently pliable to apply pressure to both the cables and the surface as it rolls along both. More specifically, the middle tape applying portion 70 radially deforms, compresses, etc., in a middle portion to apply pressure to the cables. The middle tape applying portion 70 also radially deforms, compresses, etc. in lateral portions to apply pressure to the surface on each side of the cables and to accommodate the surface contour. The middle and lateral portions can deform as needed to continuously and evenly apply pressure to the cables and any uneven surface. In that regard, with the tape disposed between the middle tape applying portion 70 and the cables/surface, the tape is adhered to both the cables and the surface as the middle tape applying portion 70 is rolled along the cables.

To accommodate the compression of the middle tape applying portion 70, the lateral rear rolling wheels 74 and 78 are sufficiently smaller in diameter than the middle tape applying portion 70. In this manner, when the middle tape applying portion 70 compresses to apply pressure to the cables/surface, the lateral rear rolling wheels 74 and 78 engage the surface to allow the body 14 to roll along the surface. However, it should be appreciated that the lateral rear rolling wheels 74 and 78 may instead be eliminated, with the body 14 rolling along the surface solely through the middle tape applying portion 70.

The middle tape applying portion 70 may be made from any suitable material for sufficiently applying pressure to both the cables and the surface. For instance, the middle tape applying portion 70 may be made from foam, rubber, or another suitable material. It should be appreciated that the middle tape applying portion 70 may instead be substantially rigid with a center radial groove for receiving the cables and lateral portions on each side of the groove for engaging the surface. The groove would be of a sufficient depth to apply pressure to the cables while the lateral portions maintained pressure on the surface. Thus, it should be appreciated that any suitable configuration for simultaneously applying pressure to the bundled cables and the surface may be used.

As noted above, tape is fed between the middle tape applying portion 70 and the cables/surface such that the middle tape applying portion 70 may simultaneously apply tape to both the cables and the surface. The tape is dispensed from the tape assembly 12 secured within the tape applicator assembly 10.

Referring to FIGS. 5-7, a portion of the tape assembly 12 and the structure for securing the tape assembly 12 within the tape applicator assembly 10 will now be described in detail. The tape assembly 12 includes a tape roll 90 wound around or otherwise positioned circumferentially on a core 94. The core 94 is substantially cylindrical in shape and defines a core axial length that accommodates the width of the tape roll 90. The core 94 may be any suitable core axial length to accommodate various size tape rolls, such as 2 inches, 3 inches, etc. The core 94 also defines an interior cylindrical opening extending along the core axial length. The hollow cylindrical opening has an interior core diameter that is sized and configured to receive a hub 98, which is removably securable within the tape-receiving cavity 36 of the body 14 to secure the tape assembly 12 within the tape applicator 10.

The hub 98, like the core 94, is cylindrical in shape and is defined by a web assembly 116 extending between an exterior cylindrical body portion 120 and an interior cylindrical body portion 122, with a center axial through-hole 118 extending axially through the interior cylindrical body portion 122. It should be appreciated that the web assembly 116 decreases the cost and weight of the hub 98; however, the hub 98 may instead be defined by a solid body extending between the exterior and interior cylindrical body portions 120 and 122.

The hub 98 defines an exterior diameter that is substantially equal to the interior diameter of the core 94. In this manner, the core 94 may be removably, yet securely disposed on the hub 98 for use within the tape applicator assembly 10. The hub 98 defines a hub axial length that is sized to be removably received within the core 94. The hub 98 may have any suitable axial length to accept various-sized cores 94 while at the same time being sized and configured to be received within the tape-receiving cavity 36 of the body 14.

A core centering and locking assembly 100 is defined between the core 94 and hub 98 for securing and centering the core 94 onto the hub 98. Although any suitable centering and locking assembly may be used, in the depicted embodiment, the core centering and locking assembly 100 comprises a first locking feature, such as a protrusion or nub 102, defined on the exterior surface of the hub 98 that is receivable within a second locking feature, such as an annular groove 106, defined on the interior surface of the core 94 to secure the core 94 onto the hub 98. It should be appreciated that the nub 102 may instead be defined on the hub 98, and the annular groove 106 defined on the core 94.

The nub 102 and annular groove 106 are positioned on the hub 98 and core 94, respectively, such that the core 94 is automatically centered axially on the hub 98 when the nub 102 is received within the annular groove 106. In other words, the nub 102 is substantially centered axially on the hub 98, and the annular groove 106 is substantially centered axially on the core 94. In this manner, the core 94 will be automatically centered axially on the hub 98 when the nub 102 is received within the annular groove 106. With the groove 106 centered axially on the core 94, it should be appreciated that regardless of its axial length (i.e., 1 inch in axial length, 2 inches in axial length, 3 inches in axial length, etc.), the core 94 will be automatically centered on the hub 98.

The tape assembly 12 is further secured on the hub 98 through a hub locking assembly 110. The hub locking assembly 110 is defined by a shaft 130 secured within the body 14 and extending into the tape-receiving cavity 36. The shaft 130 includes an anchor 134 defined at a first end that is secured within an anchor protrusion 138 extending upwardly from one side of the body 14. The shaft 130 extends into the tape-receiving cavity 36 substantially transversely to the anchor protrusion 138 such that the shaft 130 is substantially parallel to the bottom surface of the body 14.

With the shaft 130 extending into the tape-receiving cavity 36 in this manner, the hub 98 may be removably and rotatably secured on the shaft 130 for securing a desired tape roll 90 within the tape applicator assembly 10. The hub 98 may be removably and rotatably secured on the shaft 130 by passing the shaft 130 though the center through-hole 118. When received on the shaft 130, the hub 98 is rotatable about the center longitudinal axis of the shaft 130 for dispensing tape.

A bearing subassembly 114 is defined between the shaft 130 and hub 98 to accommodate the rotation of the hub 98. Although any suitable bearing subassembly may be used, the bearing subassembly 114 includes first and second flanged bushings 144 and 148 disposed at each end of the shaft 130 between the shaft 130 and the interior cylindrical body portion 122 of the hub 98. In that regard, a cylindrical gap is defined between the exterior surface of the shaft 130 and the interior surface of the internal cylindrical body portion 122 for receiving the first and second flanged bushings 144 and 148. The first and second flanged bushings 144 and 148 may be secured within the center through-hole 118 of the hub 98 such that the bushings 144, 148 and the hub 98 are an assembled unit for easier assembly and disassembly.

The hub locking assembly 110 further includes a fastening subassembly 152 configured for selectively locking the hub 98 onto the shaft 130. The fastening subassembly 152 may include a fastener 156, such as a bolt, threadably receivable within a threaded opening (not labeled) in a second end of the shaft 130 (opposite the anchor 134). A knob 160 is integrally formed on or otherwise secured on the fastener 156 near the head of the fastener such that the threaded end of the fastener protrudes from the knob 160. The knob 160 is suitably graspable by a user for applying torque to the fastener 156 and securing the threaded end of the fastener 156 within the shaft 130. A washer 164 is disposed between the knob 160 and the hub 98 for allowing the knob 160 to be selectively engaged with and tightened against the hub 98. By tightening the knob 160 against the hub 98, the ease of which the hub 98 may rotate on the shaft 130 may be adjusted.

Referring to FIG. 7, an exemplary embodiment of a tape assembly 12 having a tape roll 90 will now be described in further detail. The tape roll 90 is defined by an elongated piece of tape 164 wound around the core 94. The tape 164 includes an exterior surface 168 and an opposite, interior surface 172. A pressure sensitive adhesive 176 is disposed on the interior surface 172 and is removably secured to the exterior surface 168 when configured on the roll 90.

The pressure sensitive adhesive 176 includes a middle adhesive portion 180 extending along a center longitudinal axis of the tape on the interior surface 172 of the tape 164. The middle adhesive portion 180 is disposed between first and second lateral adhesive portions 184 and 188, which are sufficiently tacky to be removably adhered to a desired surface, such as a floor or wall.

The middle adhesive portion 180 is configured to removably adhere to the bundled cables C being taped to the surface S. In that regard, the middle adhesive portion 180 is sufficiently wide to cover and engage the aligned, bundled cables passing through the tape applicator assembly 10. The width of the middle adhesive portion 180 may be varied on different tape rolls to accommodate cable bundles of different sizes.

The middle adhesive portion 180 is also is less tacky than the first and second lateral adhesive portions 184 and 188 for releasably engaging the bundled cables. The middle adhesive portion 180 may be defined by a less tacky adhesive covering substantially the entire middle adhesive portion 180. In the alternative, the middle adhesive portion 180 may be defined by a pattern of adhesive coating (such as longitudinal or horizontal stripes, dots, etc.) that creates an overall less tacky area. Thus, it should be appreciated that the less tacky middle adhesive portion 180 may be defined in any suitable manner.

As noted above, typical gaffer tape includes a pressure-sensitive adhesive covering the entire interior surface of the tape that is sufficiently strong to secure the cable run to a surface until the tape is manually removed with a predetermined amount of force. The adhesive needs to be sufficiently strong to safely adhere to a desired surface without being easily removed due to foot traffic, etc. However, this stronger adhesive can cause the tape to become wrapped around or folded between the cable(s), causing the tape to stick to itself during the removal process. Moreover, when cables are “gaffed” often, adhesive residue builds up on the cables, making it more difficult to remove the tape from the cable.

With the middle adhesive portion 180 defining a channel of decreased tackiness, the tape 164 may be easily removed from the cables when the tape 164 is pulled up from the surface. If the middle adhesive portion 180 is at least somewhat tacky (e.g., a semi-dry channel), the tape 164 can stick to the cables and help maintain the alignment and straightness of the cables when being taped to the surface. For instance, the middle adhesive portion 180 may be between about 10-30% of the tackiness of the first and second lateral adhesive portions 184 and 188. However, it should be appreciated that the middle adhesive portion 180 may instead have no adhesive (e.g., a dry channel), or it may have greater than 30% tackiness if desired. In other words, the middle adhesive portion 180 may be between 0-99% of the tackiness of the first and second lateral adhesive portions 184 and 188 to define a less tacky middle adhesive portion 180 for releasably engaging the cables.

It should be appreciated that the tape roll 90 may instead be configured as tape strips, sheets, or another configuration for use apart from the tape applicator assembly 10. Moreover, although the tape applicator assembly 10 is shown and described in use with a tape assembly 12 having a middle adhesive portion 180 of decreased tackiness, the tape applicator assembly 10 may instead be used with any suitable tape. For instance, if the tape applicator assembly 10 is being used to mark boundary lines on a floor, rather than taping cables to the floor, a tape having any suitable pressure sensitive adhesive on its interior surface may be used. Thus, the description and illustrations provided herein should not be seen as limiting the scope of the claimed subject matter.

Referring back to FIG. 5, the operation of the tape applicator assembly 10 for taping cables to a surface will now be provided. Prior to using the tape applicator assembly 10, the proper width of the tape (i.e., its axial length) may be determined for the intended use. For instance, if 2-3 cables need to be taped to a surface, a tape roll that is, for example, 2-3 inches wide, and having a middle adhesive portion 180 sufficiently wide and tacky, may be used. In the alternative, if the tape applicator assembly 10 is merely being used to mark boundary lines on a surface, a tape roll that is, for example only 1 inch wide with no middle adhesive portion, may instead be used. Thus, depending on the intended use, a preferred tape roll 90 may be installed within the tape applicator assembly 10 or switched with a tape roll 90 already installed within the tape applicator assembly 10.

The tape roll 90 is installed within the tape applicator assembly 10 by centering and locking the core 94 on the hub 98 with the core centering and locking assembly 100. More specifically, the core 94 is slid onto the hub 98 until the nub 102 is received within the annular groove 106. It can be appreciated that when the nub 102 is received within the annular groove 106, a “snap-fit” tactile sensation will be felt by the user to indicate the core 94 is properly positioned on the hub 98. Markings, instructions, etc., may be provided on the exterior of the body 14, core 94, and/or hub 98 to aid in proper assembly.

With the core 94 assembled on the hub 98, the hub 98 may be secured within the body 14 through the hub locking assembly 110. More specifically, the hub 98 is secured onto the shaft 130 by passing the shaft 130 through the center through-hole 118 of the hub 98. The fastener 156 is then secured within the shaft 130 to secure the hub 98 onto the shaft 130 for rotation of the tape roll 90 within the tape applicator assembly 10. The fastener 156 may be tightened or loosened to increase or decrease the tension of the knob 160 against the washer 164. With increased tension from the knob 160, the tape roll 90 will unravel less easily and quickly. Thus, it can be appreciated than the tension from the knob 160 may be adjusted as desired.

Once the core 94 is secured within the tape applicator assembly 10, the tape roll 90 may be partially unraveled to position the tape 164 for dispensing. In the alternative, the tape roll 90 may be partially unraveled before securing the core 94 on the hub 98. The tape 164 is pulled from the tape roll 90 from the bottom, interior, open surface of the body 14 downwardly past the rear wheel assembly 66. The end of the tape 164 may be secured to the surface S and/or cables C for defining a first end of a cable run R.

A tape tensioner 194 may be disposed within the interior of the body 14 between the tape roll 90 and the rear wheel assembly 66 for maintaining tension in the tape 164 as it is dispensed from the roll 90. The tape tensioner 194 may be a suitable roller or other device journaled for rotation within an interior side of the body 14 in a suitable manner. To effectively maintain tension in the tape 164, the tape tensioner 194 is positioned downwardly from a tangent defined between the tape roll 90 and the rear wheel assembly 66. In this manner, the tape tensioner 194 imposes a downward force on the tape 164 to maintain a substantially constant tension while being dispensed. With tension in the tape 164, the rear wheel assembly 66 maintains better tape alignment on the surface/cables and reduces any wrinkles, gaps, etc.

The middle tape applying portion 70 partially compresses to apply pressure to both the cables C and the surface S as the tape 164 passes over the rear wheel assembly 66. More specifically, with the cables C centrally aligned after passing through the funnel 52 (and held taught by the flat spring 60), a central portion of the middle tape applying portion 70 compresses to accommodate the height and shape of the cables C relative to the surface S. Moreover, the lateral edges of the middle tape applying portion 70 compress to apply pressure to the surface S on each side of the cables C for sealing the cables C beneath the tape 164.

It can be appreciated from the foregoing that the tape applicator assembly 10 and tape assembly 12 provide the benefit of securing aligned, bundled, taught cable(s) to a surface without causing the tape to irreversibly stick to or leave residue on the cable(s). However, while illustrative embodiments have been illustrated and described, it will be appreciated that various changes can be made therein without departing from the spirit and scope of the present disclosure.

1. A tape applicator assembly for securing tape to a surface, comprising:
(a) a body; and
(b) a centering and locking assembly configured to automatically center and lock a tape assembly within the body for dispensing.

2. The assembly of claim 1, wherein the tape assembly includes tape having an exterior surface, an interior surface, and a middle adhesive portion extending longitudinally along the interior surface between first and second lateral adhesive portions, wherein the middle adhesive portion is less tacky than the first and second lateral adhesive portions.

3. The assembly of claim 1, wherein the tape assembly includes a tape roll secured on a core having a core axial length, the core removably receivable axially on a hub having a hub axial length, and the hub rotatably securable within the body.

4. (canceled)

5. The assembly of claim 3, wherein the centering and locking assembly further comprises a first locking feature defined on an interior cylindrical surface of the core that is configured to interface with a second locking feature defined on an exterior cylindrical surface of the hub.

6. (canceled)

7. The assembly of claim 5, wherein the first locking feature is one of a protrusion and an annular groove, and wherein the second locking feature is the other of the protrusion and the annular groove, the protrusion removably receivable within the annular groove.

8-13. (canceled)

14. A tape applicator assembly for securing tape to at least one cable and a surface, comprising:
(a) a body moveable along at least one cable positioned on a surface;
(b) a tape-receiving cavity defined in the body for receiving a tape assembly having tape, wherein the tape assembly is receivable within the tape-receiving cavity such that the tape is positioned for dispensing from the body; and
(c) a tape applying assembly defined within the body, the tape applying assembly configured to adhere the tape to both the at least one cable and the surface as the body moves along the at least one cable on the surface.

15. The assembly of claim 14, wherein the tape applying assembly comprises a wheel assembly having a tape applying portion that is deformable to apply pressure to both the at least one cable and the surface as the body moves along the at least one cable on the surface.

16. (canceled)

17. The assembly of claim 14, further comprising a centering and locking assembly configured to automatically center and lock the tape assembly within the body for dispensing.

18. The assembly of claim 17, wherein the tape assembly includes tape having an exterior surface, an interior surface, and a middle adhesive portion extending longitudinally along the interior surface between first and second lateral adhesive portions, wherein the middle adhesive portion is less tacky than the first and second lateral adhesive portions.

19. The assembly of claim 17, wherein the tape assembly includes a tape roll secured on a core having a core axial length, the core removably receivable axially on a hub having a hub axial length, and the hub rotatably securable within the body.

20. (canceled)

21. The assembly of claim 19, wherein the centering and locking assembly further comprises a protrusion centered axially on one of the core and the hub and an annular groove centered axially on the other of the core and the hub, the protrusion removably receivable within the annular groove for centering and locking the core on the hub.

22-25. (canceled)

26. A tape applicator assembly for securing tape to at least one cable and a surface, comprising:
(a) a body moveable along at least one cable positioned on a surface;
(b) a tape-receiving cavity defined in the body for receiving a tape assembly having tape with a tape center longitudinal axis, wherein the tape assembly is receivable within the tape-receiving cavity such that the tape is positioned for dispensing from the body;
(c) a cable alignment assembly defined within the body that is configured to receive the at least one cable positioned against the surface as the body moves along the at least one cable on the surface and substantially align the at least one cable with the tape center longitudinal axis.

27. The assembly of claim 26, wherein the tape has an exterior surface, an interior surface, and a middle adhesive portion extending along the tape center longitudinal axis on the interior surface of the tape between first and second lateral adhesive portions, wherein the middle adhesive portion is less tacky than the first and second lateral adhesive portions.

28. The assembly of claim 26, wherein the cable alignment assembly comprises a funnel defined within a bottom interior of the body for receiving and substantially aligning the at least one cable with the tape center longitudinal axis, the funnel defining a front cable opening at a front portion of the body and a rear cable opening opposite the front cable opening, the funnel tapering in size from the front cable opening to the rear cable opening.

29. The assembly of claim 28, wherein the funnel includes a first adjustable funnel piece configured to adjust at least one of the size and shape of the rear cable opening.

30. The assembly of claim 29, wherein the cable alignment assembly further comprises a biasing member for engaging and maintaining alignment of the at least one cable as the at least one cable exits the rear cable opening.

31. The assembly of claim 26, further comprising a tape applying assembly defined within the body, the tape applying assembly configured to adhere the tape to both the at least one cable and the surface as the body moves along the at least one cable on the surface.

32. The assembly of claim 31, wherein the tape applying assembly comprises a wheel assembly having a tape applying portion that is deformable to apply pressure to both the at least one cable and the surface as the body moves along the at least one cable on the surface.

33. (canceled)

34. The assembly of claim 26, further comprising a centering and locking assembly configured to automatically center and lock the tape assembly within the body for dispensing.

35. The assembly of claim 34, wherein the tape assembly includes a tape roll secured on a core having a core axial length, and wherein the core is removably receivable axially on a hub having a hub axial length, and the hub is rotatably securable within the body.

36-45. (canceled)
